(19) United States
(12) Patent Application Publication
(10) Pub. No.: US 2011/0210022 A1
(43) Pub. Date: Sep. 1, 2011

(54) Waiter Organizer

(76) Inventor: Katrina Degel, Dorchester, MA (US)

(21) Appl. No.: 13/037,016

(22) Filed: Feb. 28, 2011

Related U.S. Application Data
(60) Provisional application No. 61/308,899, filed on Feb. 27, 2010.

(51) Int. Cl. B42F 7/06

(52) U.S. Cl. 206/232; 281/45

(57) ABSTRACT

A waiter or waitress portfolio organizer containing specifically configured pockets each of which are adapted for holding currency, a multi-page order pad, completed order receipts, billing receipts and a writing utensil. The organizer also contains easy accessible transparent pockets configured to only hold 5 or less sheets of point of sale (POS) paper receipts less than 3½ in width and 0.06 mm to 0.1 mm in thickness for waiters or waitress to easily read papers for restaurant drink or dinner specials or special waiter or waitress notes. The organizer that is built of durable materials that withstands long periods of use, maintains a sleek, professional appearance and has a thin profile for easy storage. The organizer contains a versatile, easy to use system of tools to help restaurant servers present specials to customers, take orders, maintain records of all orders, maintain bills, and maintain collected currency.

### CROSS REFERENCE TO RELATED APPLICATION

This application claims the benefit of U.S. Provisional Patent Application No.: 61/308,899 filed on Feb. 27, 2010, the contents of which are incorporated herein by reference.

### FIELD OF THE INVENTION

The field of the invention relates to a portfolio-type organizer for use by waiters or waitresses to organize restaurant matters, including the presentation of specials to customers, taking of orders, maintaining records of all their orders, maintaining billing records of all their orders and maintaining collected currency.

### BACKGROUND OF INVENTION

Organizers, wallets and check presenters for waiters and waitresses of the prior art fail to provide a tool that aids these professionals in all aspects of restaurant service.

Previous wallets or organizers may include slots for holding multi-page customer order pads, slots specifically configured to hold a customer's credit card, and one generalized pocket for holding anything else. Other waiter organizers and wallets may contain bulky, cumbersome internal components, such as a plurality of envelopes, which make these organizers too thick or too complicated to use in a busy, fast-paced restaurant setting. Previous waiter organizers and wallets are often bulky, with three or more base sections, and are not as efficient, long-lasting and professional looking as check presenters.

Check presenters are usually composed of cardboard bases covered with heat-sealed vinyl or stitched leather. These check presenters may have additional padding, turned and stitched edges. Check presenters have a durable construction for long, intensive use by waiters or waitresses. Check presenters also have a professional, sleek look that is extremely important to the image projected by the restaurant to their customers. However, previous check presenters are configured for simple containment and presentation of a customer's bill, order receipt and a credit card slot for paying the bill. More advanced check presenters may contain an embedded light-emitting apparatus, magnifying tools and a calculator. All of these embedded accessories are useful for a customer, but these check presenters don't have the tools needed by a busy server.

Thus, there is need for a server organizer that is built of durable materials to withstand long periods of use, that maintains a sleek, professional appearance, that has a slim profile for storage in large apron or pants pockets, and that contains a versatile, easy to use system of tools to help restaurant servers present specials to customers, take orders, maintain records of all orders, maintain bills, and maintain collected currency.

### SUMMARY OF THE INVENTION

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

The subject invention discloses a waiter/waitress organizer comprising: a portfolio having a first cover and a second cover being pivotally connected with a flexible hinge; a first pocket on the internal surface of the first cover, wherein the first pocket is configured to removably hold a plurality of currency bills in a readily accessible position; a second pocket on the internal surface of the second cover, wherein the second pocket is configured to removably hold a backing sheet of a multi-page pad in a steady position on the portfolio; a first corner pocket on the top surface of the first pocket; a second corner pocket on the top surface of the second pocket, wherein the first and second corner pockets are substantially mirror images of each other; a first substantially transparent pocket on the top surface of the first corner pocket; and a second substantially transparent pocket on the top surface of the second corner pocket.

Another embodiment of the subject invention is a waiter/waitress organizer comprising: a substantially flat first base and substantially flat second base sealed within a cover, wherein the cover attaches both bases along a common side with a flexible hinge to form a foldable portfolio; a horizontal pocket with an opening that extends along the hinge on the internal surface of the first base, wherein the horizontal pocket is configured to removably hold a plurality of currency bills in a readily accessible position; a vertical pocket on the internal surface of the second base, wherein the vertical pocket has an opening that extends along the top edge of the second base, further wherein the vertical pocket is configured to removably hold a backing sheet of a multi-page pad to maintain the pad disposedly on the internal surface of the second base; a first corner pocket on the top surface of the horizontal pocket on the internal surface of the first base, wherein the first corner pocket has a continuous opening that extends vertically along the hinge of the portfolio and then curves outward towards a free edge of the first base, wherein the first corner pocket is configured to removably hold a plurality of documents in a readily accessible position; a second corner pocket on the top surface of the vertical pocket on the internal surface of the second base, wherein the second corner pocket has a continuous opening that extends vertically along the hinge of the portfolio and then curves outward towards a free edge of the second base, wherein the second corner pocket is configured to removably hold a plurality of documents in a readily accessible position, further wherein the first and second corner pockets are substantially mirror images of each other; a first window pocket on the top surface of the first corner pocket on the internal surface of the first base, wherein the first window pocket is substantially transparent and has an opening that is substantially parallel with the top edge of the first base, wherein the first window pocket is configured to removably hold a plurality of documents less than 3½ inches in width; and a second window pocket on the top surface of the second corner pocket on the internal surface of the second base, wherein the second window pocket is substantially transparent and has an opening that is substantially parallel with the top edge of the second base, wherein the second window pocket is configured to removably hold a plurality of documents less than 3½ inches in width.

In this embodiment of the subject invention, the waiter/waitress organizer may further comprise a third window pocket on the top surface of the first window pocket on the internal surface of the first base, wherein the third window pocket is substantially transparent and has an opening that is substantially diagonal with the top edge of the first base, wherein the third window pocket is configured to removably hold a plurality of documents less than 3½ inches in width.

In this embodiment of the subject invention, the waiter/waitress organizer may further comprise a fourth window pocket on the top surface of the second window pocket on the internal surface of the second base, wherein the fourth window pocket is substantially transparent and has an opening that is substantially diagonal with the top edge of the second base, wherein the fourth window pocket is configured to removably hold a plurality of documents less than 3½ inches in width.

In this embodiment of the subject invention, the first, second, third and fourth window pockets may each have a width less than 3½ inches. In this embodiment of the subject invention, the first, second, third and fourth window pockets may each only hold 5 or less sheets of standard point of sale (POS) paper receipts each having a thickness of 0.06 mm to 0.1 mm.

In this embodiment of the subject invention, the waiter/waitress organizer may further comprise a hinge pocket on the flexible hinge configured for removably holding a writing utensil with the portfolio is in the open and closed positions.

A further embodiment of the subject invention is a waiters'/waitresses' organizer comprising: a substantially planar first panel having a substantially rectangular shape and opposing first and second faces; a substantially planar second panel having a substantially rectangular shape and opposing third and fourth faces; a flexible hinge joining an edge of the first panel to an edge of the second panel, the hinge allowing movement of the first panel and the second panel about the hinge to define a closed position wherein the second face of the first panel is positioned adjacent to, and substantially parallel with, the third face of the second panel, and an open position wherein the second face of the first panel is rotated away from the third face of the second panel; a first pocket disposed on the second surface of the first panel, wherein the first pocket has an opening extending along and substantially parallel with the hinge, further wherein the first pocket is configured to removably hold a plurality of currency bills in a readily accessible position; a second pocket disposed on the third surface of the second panel, wherein the second pocket has an opening extending along and substantially parallel with the top edge of the second panel, further wherein the second pocket is configured to removably hold a backing sheet of a multi-page pad to maintain the pad disposedly on the third face; a first corner pocket disposed on the first pocket, wherein the first corner pocket has a first sealed edge on the bottom of the second face and a second sealed edge on the free edge of the second face, wherein the first corner pocket has an opening that extends along the hinge and curves to extend towards the outer edge of the second face, wherein the first corner pocket is configured to removably hold documents in a readily accessible position; a second corner pocket disposed on the second pocket, wherein the second corner pocket has a third sealed edge on the bottom of the third face and a fourth sealed edge on the free edge of the third face, wherein the second corner pocket has an opening that extends along the hinge and curves to extend towards the outer edge of the third face, wherein the second corner pocket is configured to removably hold documents in a readily accessible position, further wherein the first and second corner pockets are substantially mirror images of each other; a first window pocket disposed on the first corner pocket, wherein the first window pocket is substantially transparent and has an opening that is substantially parallel with the top edge of the second face, wherein the first window pocket is configured to removably hold a plurality of paper receipts; and a second window pocket disposed on the second corner pocket, wherein the second window pocket is substantially transparent and has an opening that is substantially parallel with the top edge of the third face, wherein the second window pocket is configured to removably hold a plurality of paper receipts, further wherein the first and second window pockets are substantially the same size.

In this embodiment of the subject invention, the first and second window pockets may each have a width less than 3½ inches. In this embodiment of the subject invention, the first and second window pockets may each only hold 5 or less sheets of standard point of sale (POS) paper receipts each having a thickness of 0.06 mm to 0.1 mm.

In this embodiment of the subject invention, the waiter/waitress organizer may further comprise a corner window pocket disposed on the first window pocket, wherein the corner window pocket has an opening that extends along in a direction substantially 45 degrees to the bottom edge of the second face.

In this embodiment of the subject invention, the waiter/waitress organizer may further comprise a second corner window pocket disposed on the second window pocket, wherein the second corner window pocket has an opening that extends along in a direction substantially 45 degrees to the bottom edge of the third face.

In this embodiment of the subject invention, the first and second corner window pockets may each have a width less than 3½ inches. In this embodiment of the subject invention, the first and second corner window pockets may each only hold 5 or less sheets of standard point of sale (POS) paper receipts each having a thickness of 0.06 mm to 0.1 mm.

In this embodiment of the subject invention, the waiter/waitress organizer may further comprise a hinge pocket on the flexible hinge configured for removably holding a writing utensil with the portfolio is in the open and closed positions.

An additional embodiment of the subject invention is a server organizer comprising: a substantially planar first panel having a substantially rectangular shape and opposing first and second faces; a substantially planar second panel having a substantially rectangular shape and opposing third and fourth faces; a flexible hinge joining an edge of the first panel to an edge of the second panel, the hinge allowing movement of the first panel and the second panel about the hinge to define a closed position wherein the second face of the first panel is positioned adjacent to, and substantially parallel with, the third face of the second panel, and an open position wherein the second face of the first panel is rotated away from the third face of the second panel; a substantially planar first sheet disposed on the second surface of the first panel, wherein the first sheet is attached to three edges of the second surface to form a first pocket with a first opening, wherein the first opening extends along and is substantially parallel with the hinge, further wherein the first sheet is loosely attached to the second surface to removably hold a plurality of currency bills in a readily accessible position; a substantially planar second sheet disposed on the third surface of the second panel, wherein the second sheet is attached to three edges of the third surface to form a second pocket with a second opening, wherein the second opening extends along and is substantially parallel with the top of the second panel, further wherein the second pocket is configured to removably hold a backing sheet of a multi page pad to maintain the pad disposedly on the third face; a substantially planar third sheet disposed on the outer surface of the first sheet, wherein the third sheet is attached to the bottom and free edges of the second face to form a first corner pocket with a third opening, wherein the first corner pocket is configured to removably hold paper documents in a readily accessible position; a substantially planar fourth sheet disposed on the outer surface of the second sheet, wherein the fourth sheet is attached to the bottom and free edges of the third face to form a second corner pocket with a fourth opening, wherein the second corner pocket is configured to removably hold paper documents in a readily accessible position, wherein the first and second corner pockets are substantially mirror images of each other; a substantially planar fifth sheet disposed on the outer surface of third sheet, wherein the fifth sheet is comprised of substantially transparent material and is attached on three edges to form a first window pocket with a fifth opening, wherein the first window pocket is configured to removably hold a plurality of paper receipts smaller than 3½ inches in width; a substantially planar sixth sheet disposed on the outer surface of fourth sheet, wherein the sixth sheet is comprised of substantially transparent material and is attached on three edges to form a second window pocket with a sixth opening, wherein the second window pocket is configured to removably hold a plurality of paper receipts smaller than 3½ inches in width, wherein the first and second window pockets are substantially the same size.

In this embodiment of the subject invention, the first and second window pockets may each have a width less than 3½ inches. In this embodiment of the subject invention, the first, second, third and fourth window pockets may each only hold 5 or less sheets of standard point of sale (POS) paper receipts each having a thickness of 0.06 mm to 0.1 mm.

In this embodiment of the subject invention, the server organizer may further comprise a substantially planar triangular sheet disposed on the outer surface of the fifth sheet, wherein the triangular sheet comprises a substantially transparent material and is attached on the bottom edge and free edge of the second face to form a corner window pocket, wherein the corner window pocket is configured to hold point of sale (POS) paper receipts.

In this embodiment of the subject invention, the server organizer may further comprise a second substantially planar triangular sheet disposed on the outer surface of the sixth sheet, wherein the triangular sheet comprises a substantially transparent material and is attached on the bottom edge and free edge of the third face to form a second corner window pocket, wherein the second corner window pocket is configured to hold point of sale (POS) paper receipts.

In this embodiment of the subject invention, the first and second corner window pockets may each have a width less than 3½ inches. In this embodiment of the subject invention, the first and second corner window pockets may each only hold 5 or less sheets of standard point of sale (POS) paper receipts each having a thickness of 0.06 mm to 0.1 mm.

In this embodiment of the subject invention, the server organizer may further comprise a substantially planar eighth sheet disposed on the flexible hinge, wherein the eighth sheet is attached to the hinge on three edges to form a hinge pocket, wherein the hinge pocket is configured to removably hold a writing utensil.

In other embodiments of the subject invention, the waiter/waitress organizer may comprise a cover of leather or vinyl material. In further embodiments of the subject invention all sheets forming pockets may comprise a leather or vinyl material.

In further embodiments of the subject invention, the waiter/waitress organizer may further comprise a third substantially transparent pocket on the top surface of the first substantially transparent pocket.

In other embodiments of the subject invention, the waiter/waitress organizer may further comprise a fourth substantially transparent pocket on the top surface of the second substantially transparent pocket.

In additional embodiments of the subject invention, the waiter/waitress organizer may further comprise a hinge pocket on the flexible hinge, wherein the hinge pocket may be configured for removably holding a writing utensil with the portfolio in the open and closed positions.

In other embodiments of the subject invention, the first and second corner pockets may each be 4 to 7 inches in height. In further embodiments of the subject invention, the first and second corner pockets may each be 3 to 5 inches in height.

In other embodiments of the subject invention, the multi-page pad may be a standard pad of restaurant order receipts.

In additional embodiments of the subject invention, the first and second substantially transparent pockets may be configured for holding point of sale (POS) paper receipts less than 3.5 inches in width. In other embodiments of the subject invention, the first and second substantially transparent pockets may each have a width less than 3½ inches. In further embodiments of the subject invention, the first and second substantially transparent pockets may each only hold 5 or less sheets of standard point of sale (POS) paper receipts each having a thickness of 0.06 mm to 0.1 mm.

In other embodiments of the subject invention, the waiter/waitress organizer may further comprise metal corners on the outer corner edges of the front and back covers.

In further embodiments of the subject invention, the front and back covers may each be 6 to 12 inches in height.

In other embodiments of the subject invention, the front and back covers may each be 4 to 7 inches in width.

In additional embodiments of the subject invention, the portfolio may be less than 2 inches in thickness in the closed position and less than 1 inch in thickness in the open position.

There have thus been broadly outlined important features of the invention in order that the detailed description thereof that follows may be better understood, and in order that the present contribution to the art may be better appreciated. There are additional features of the invention that will be described hereinafter and which will form the subject matter of the claims appended hereto. These together with other embodiments of the invention, and with various features of novelty which characterize the invention, are pointed out with particularity in the claims annexed to and formed as part of this disclosure.

For a conceptual understanding of the invention and its operational advantages, refer to the accompanying drawings and descriptive matter in which there are preferred embodiments of the invention illustrated. Other features and advantages of the present invention will become apparent from the following description of the preferred embodiment(s), taken in conjunction with the accompanying drawings, which by way of example; illustrate the principles of the invention.

### BRIEF DESCRIPTION OF THE DRAWINGS

Advantages of the present invention will be apparent from the following detailed description of exemplary embodiments thereof, which description should be considered in conjunction with the accompanying drawings:

FIG. 1 illustrates a top view of one embodiment of the empty waiter organizer with outer edge metal corners in the open position.

FIG. 2 illustrates another top view of one embodiment of the waiter organizer in the open position with a mounted multi-page order pad, specifically configured pockets each containing either currency, order checks or a writing utensil, and a transparent pocket configured for holding a small receipt.

FIG. 3 illustrates another top view of one embodiment of the waiter organizer with a multi-page order pad positioned for attachment, and currency, order checks, a writing utensil and a small receipt positioned for placement in pockets specifically configured to removably hold these items.

FIG. 4 illustrates a top view of another embodiment of the empty waiter organizer with outer metal corners in the open position.

FIG. 5 illustrates a top view of a further embodiment of the empty waiter organizer without outer metal corners in the open position.

FIG. 6 illustrates a top view a top view of an additional embodiment of the empty waiter organizer without outer metal corners in the open position.

FIG. 7 illustrates a top view of one embodiment of the waiter organizer in the open position with a mounted multi-page order pad, specifically configured pockets each containing either currency, order checks or a writing utensil, and transparent pockets configured for holding a small receipts.

FIG. 8 illustrates a top view of another embodiment of the waiter organizer in the open position with outer metal corner edges and a mounted multi-page order pad, specifically configured pockets each containing either currency, order checks or a writing utensil, and transparent pockets configured for holding a small receipts.

FIG. 9 is an image of one embodiment of the empty waiter organizer in the open position.

FIG. 10 is an image of a top view of one embodiment of the waiter organizer in the open position with a mounted multi-page order pad, specifically configured pockets each containing either currency, order checks or a writing utensil, and transparent pockets configured for holding a small receipts.

FIG. 11 is an image of a top view of another embodiment of the waiter organizer in the open position with outer metal corner edges and a mounted multi-page order pad, specifically configured pockets each containing either currency, order checks or a writing utensil, and transparent pockets configured for holding a small receipts.

### DETAILED DESCRIPTION OF EMBODIMENTS

The following will describe, in detail, several embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

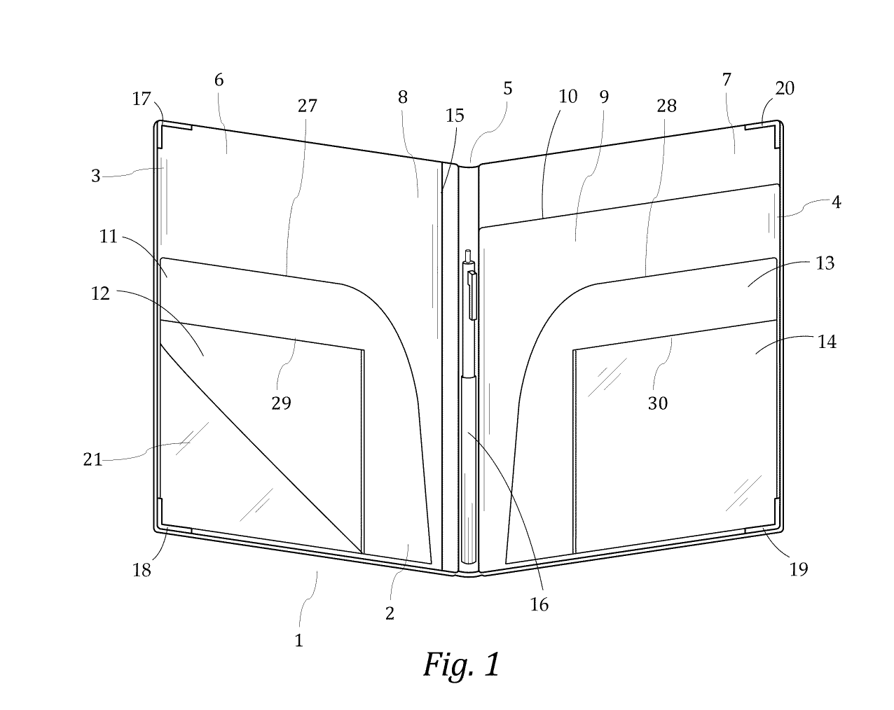

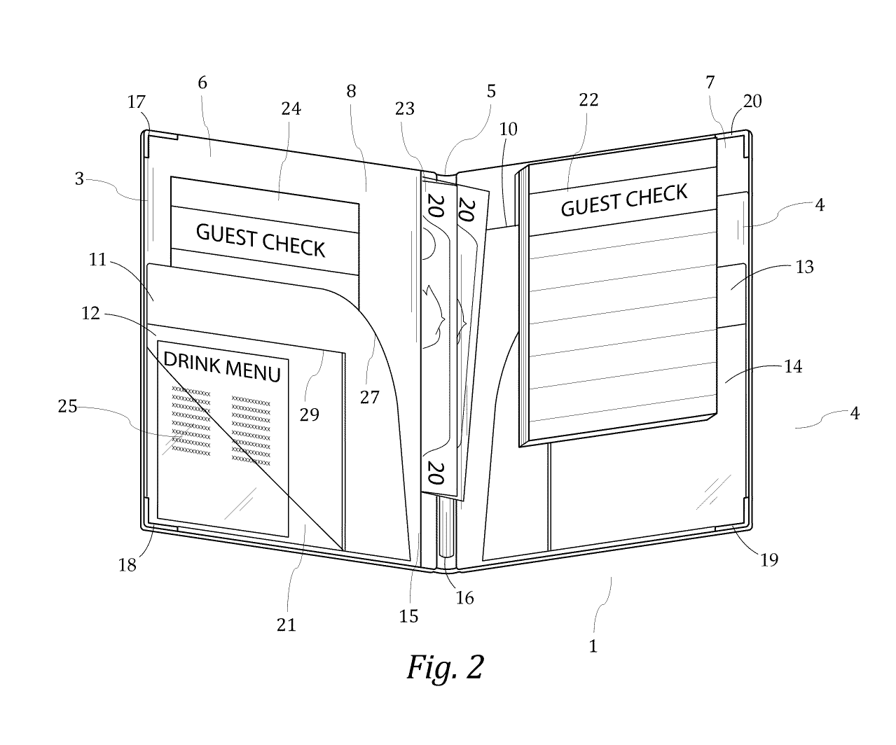

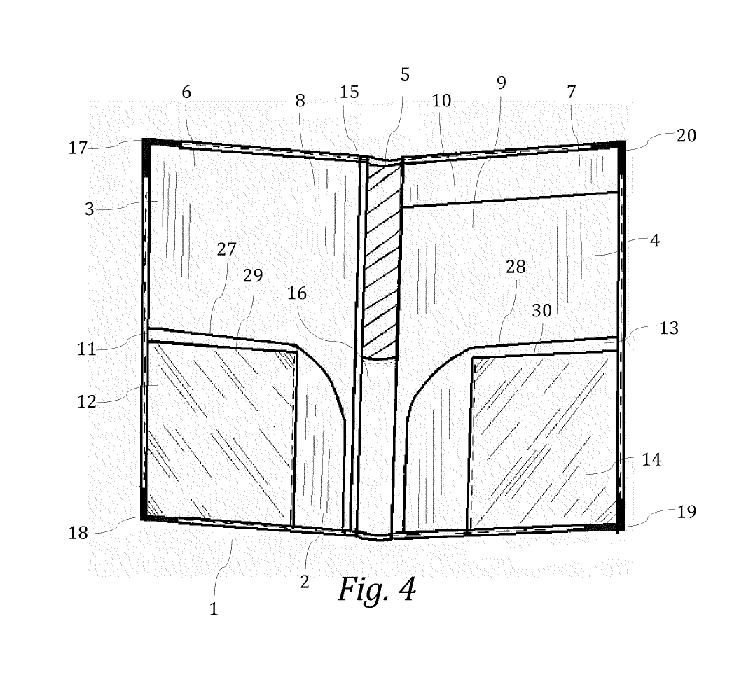

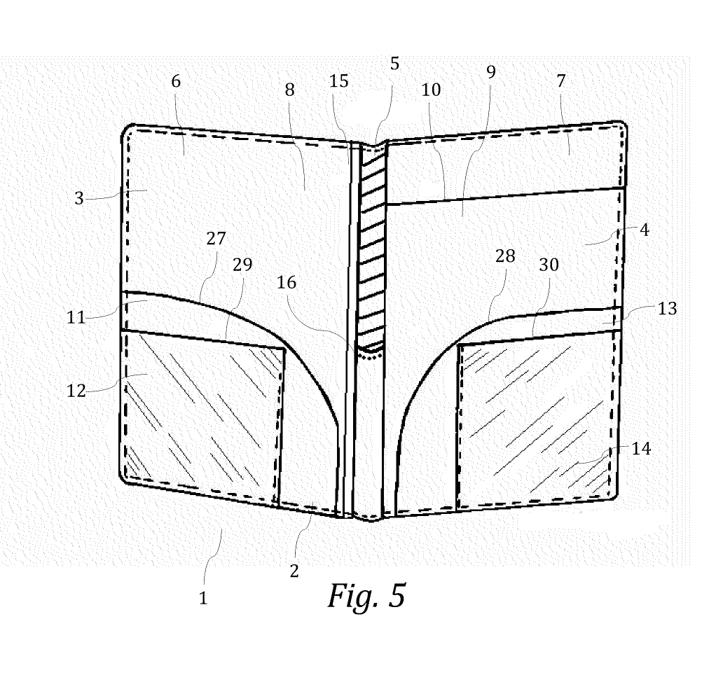

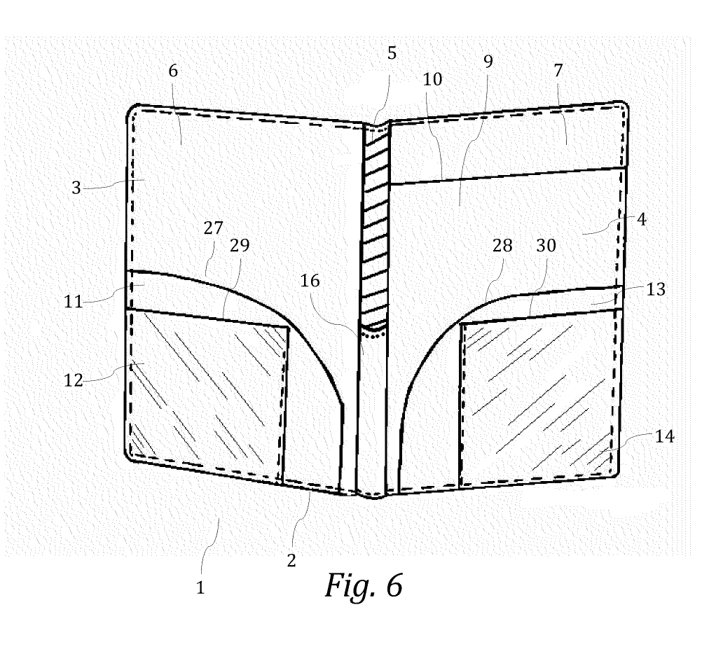

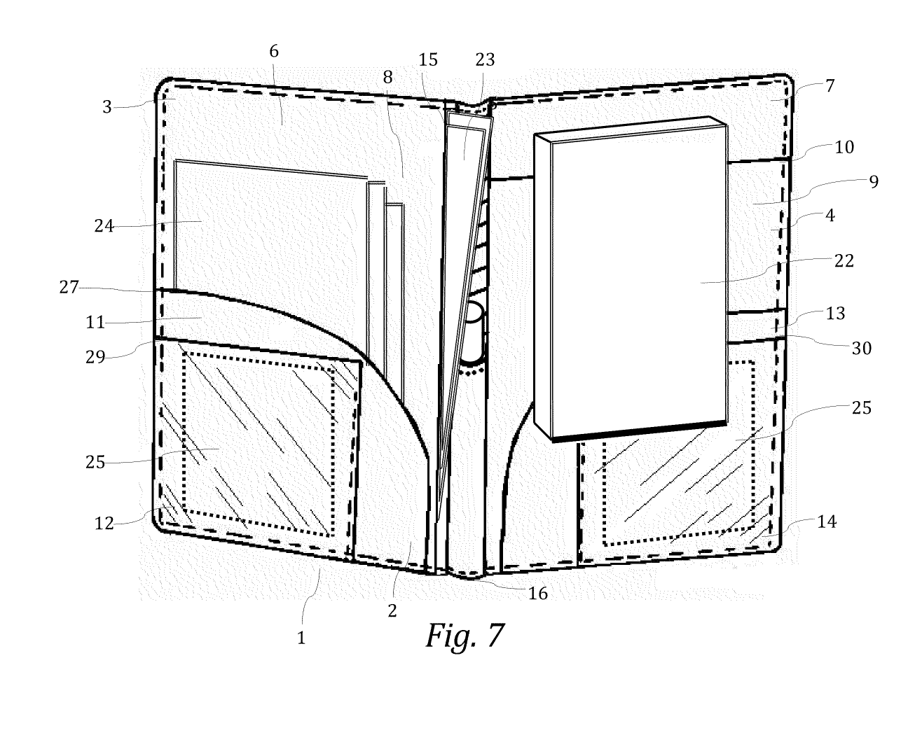

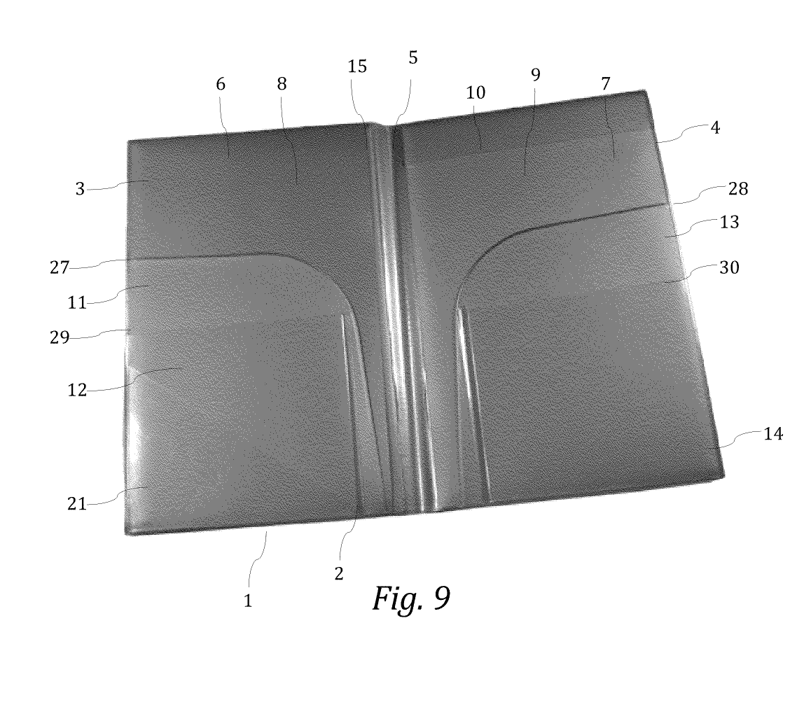

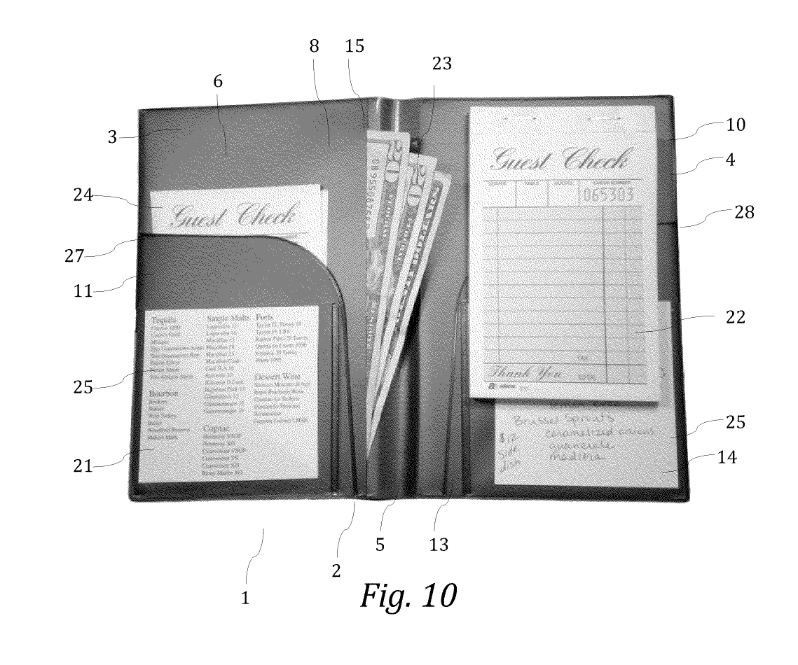

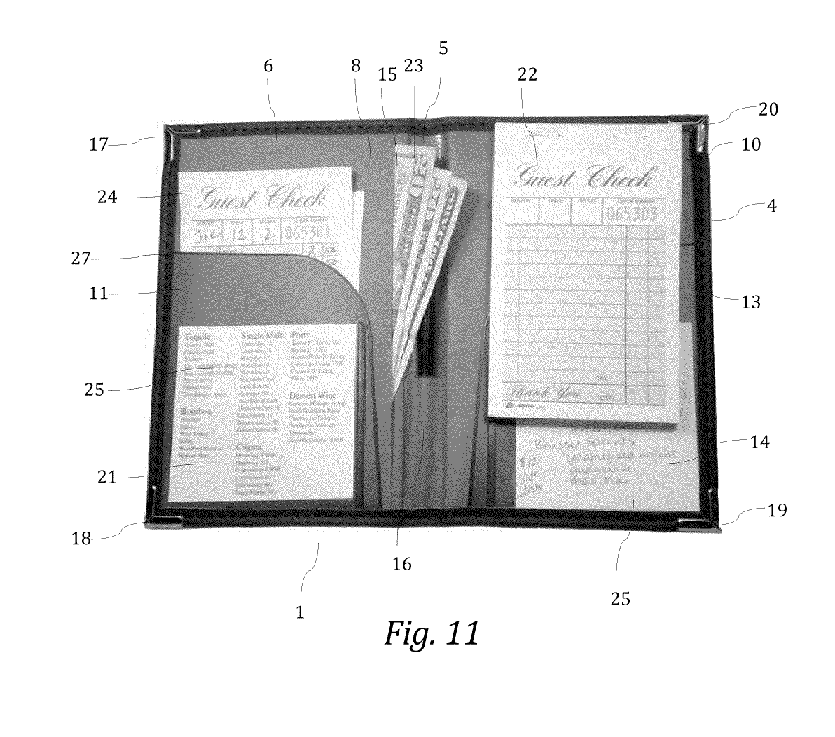

As shown in FIGS. 1-11, the present invention is a waiter organizer 1 comprised of a vinyl or leather cover 2 attached over two flat, rectangular cardboard bases or panels 3 and 4. The cover 2 connects both bases 3 and 4 along a common edge with a flexible hinge 5 to form a foldable portfolio structure. This cover 2, and all pockets described herein, may be heat-sealed, stitched, or glued together with adhesives over bases 3 and 4 as known to those skilled in the art. FIGS. 1-4, 8 and 11 show an embodiment of the waiter organizer 1 composed of a stitched leather cover 2 with stitched leather pockets. FIGS. 5, 7, 9 and 10 show an embodiment of the waiter organizer 1 composed of a vinyl cover 2 with vinyl pockets.

The waiter organizer 1 is sufficiently tall and wide to accommodate pockets and fit easily into an apron. The organizer 1 may be approximately 6 to 12 inches in height, 4 to 7 inches in width and less than 2 inches in thickness in the closed position, with preferred sizes of 9¼ inches tall and 5¾ inches wide, or 9 inches tall and 4³/4 inches wide when in the closed position. The organizer 1 is less than 1 inch in thickness when in the open position, with a preferred thicknesses of ⅝ or ⅞ of an inch in the open position. The organizer 1 is lightweight and thin, making it easier to carry, store and use for waiters.

The open position of the organizer 1 contains an internal left-hand surface 6 from base 3 and an internal right-hand surface 7 from base 4. These internal left and right-hand surfaces (6 and 7) contain a unique internal pocket structure. In further embodiments of the subject invention, the pocket structures disclosed below may be reversibly formed on the internal left-hand surface 6 and the internal right-hand surface 7 (not shown).

The internal left-hand surface 6 has a horizontal pocket 8 with a vertical slot opening 15 that is evenly spaced from and parallel to the common hinge 5 of the organizer 1. The opening 15 is approximately as wide as the organizer 1 is tall, minus the stitched or heat-sealed edges of the left-hand panel 6, such as 8¾ inches in width. The pocket 8 may be as deep as the remaining space from the opening 15 to the stitched or heat-sealed outer edge of the left-hand panel 6, such as 3½ to 6½ inches in depth. The horizontal pocket 8 is not tight, but loose against the surface of the left-hand surface 6 so that pocket 8 is adapted to hold multiple currency bills 23 and checks.

The internal right-hand surface 7 contains a vertical pocket 9 with a horizontal slot opening 10 that is evenly spaced from and parallel to the top edge of the internal right-hand surface 7. The pocket 9 may be as deep as the remaining space from the opening 10 to the stitched or heat-sealed bottom of the right-hand panel 7, such as 4½ to 11½ inches in depth. The opening 10 is approximately as wide as the right-hand panel 7, minus the stitched or heat-sealed edges of the right-hand panel 7, such as 4⅝ inches in width. The vertical pocket 9 is very tight against the right-hand surface 7 so that pocket 9 is adapted for firmly holding the backing of a notepad 22 within the organizer 1.

The top surface of horizontal pocket 8 contains a corner pocket 11 and the top surface of vertical pocket 9 contains a corner pocket 13. The corner pocket 11 is sealed on the bottom and along the outer edge of the internal left-hand surface 6. The corner pocket 11 has an opening 27 that extends vertically along the common hinge 5 of the organizer 1, curves around a corner and extends horizontally towards an outer edge of the internal left-hand surface 6. The corner pocket 13 is sealed on the bottom and along the outer edge of the internal right-hand surface 7. The corner pocket 13 has an opening 28 that extends vertically along the common hinge 5 of the organizer 1, curves around a corner and extends horizontally towards an outer edge of the internal right-hand surface 7. The corner pockets 11 and 13 are mirror images of each other. The corner pockets 11 and 13 each have a size that is approximately 4 to 7 inches in height and 3 to 5 inches in width, with a preferred embodiments of 5¾ inches tall and 4⅜ inches wide or 5 inches tall by 4½ inches wide.

This top surface of corner pocket 11 contains a smaller window pocket 12. The window pocket 12 is a vertical pocket attached on the bottom and both sides to the top surface of the corner pocket 11. The window pocket 12 has a horizontal slot opening 29 beneath the horizontal opening 27 of the corner pocket 11. This top surface of corner pocket 13 contains a smaller window pocket 14. The window pocket 14 is a vertical pocket attached on the bottom and both sides to the top surface of corner pocket 13. The window pocket 14 has a horizontal slot opening 30 beneath the horizontal opening 28 of the corner pocket 13. This top surface of corner pocket 11 may contain a smaller triangular shaped window pocket 21. In embodiments of the subject invention, the top surface of corner pocket 13 may also contain a triangular shaped pocket (not shown). The window pocket 21 has a diagonal opening that is disposed at a 45-degree angle from the bottom edge of the panel 3. The window pockets 12, 14 and 21 are composed a transparent material, such as a colorless or transparent colored PVC. The window pockets 12, 14 and 21 each have a size that is less than 3½ inches in width, with a preferred embodiment of 3¼ inches wide and 4 inches tall. The window pockets 12, 14, and 21 are tight enough to hold only 5 or less sheets of standard point of sale (POS) paper receipts each with standard thicknesses of 0.06 mm to 0.1 mm. The window pockets 12, 14 and 21 are meant for display to the waiter or waitress, specifically displaying of notes written or printed on standard point of sale (POS) restaurant printer paper that is 3 inches wide. These paper receipts may contain various indicia, including, but not limited to: waiter/waitress training information, restaurant specials, drink specials, up-selling techniques or personal notes.

The flexible hinge 5 contains a small horizontal slot that presents entry to a small vertical pocket 16 that is adapted to contain one end of a writing utensil 26, such as a pen or pencil. The pocket 16 may be as wide and as deep as is necessary to hold a standard writing utensil 26, such as ⅞ of an inch wide and 4 inches deep.

The organizer 1 has metal corners 17, 18, 19 and 20 of the outer corner edges of the internal left surface 6 and the right hand surface 7. FIGS. 1-4, 8 and 11 show an embodiment of the waiter organizer 1 composed of a leather cover with metal corners 17, 18, 19 and 20. The metal corners 17, 18, 19, and 20 are of sufficient width and depth to hold stitched seams together on each corner, such as 1 inch wide from each corner and 3/16 of an inch deep.

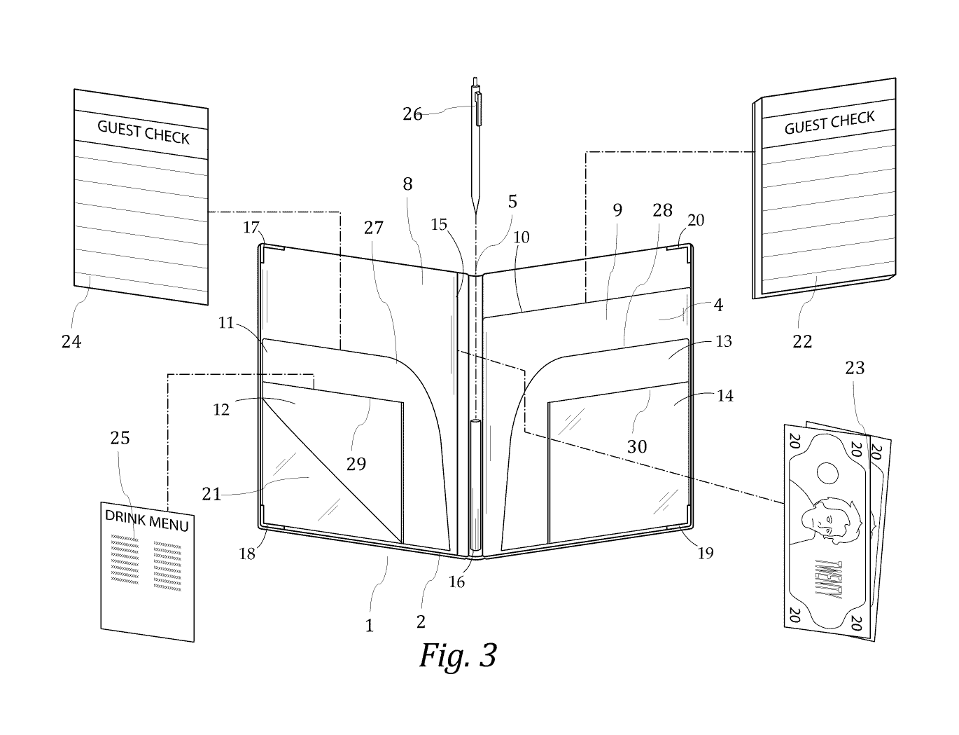

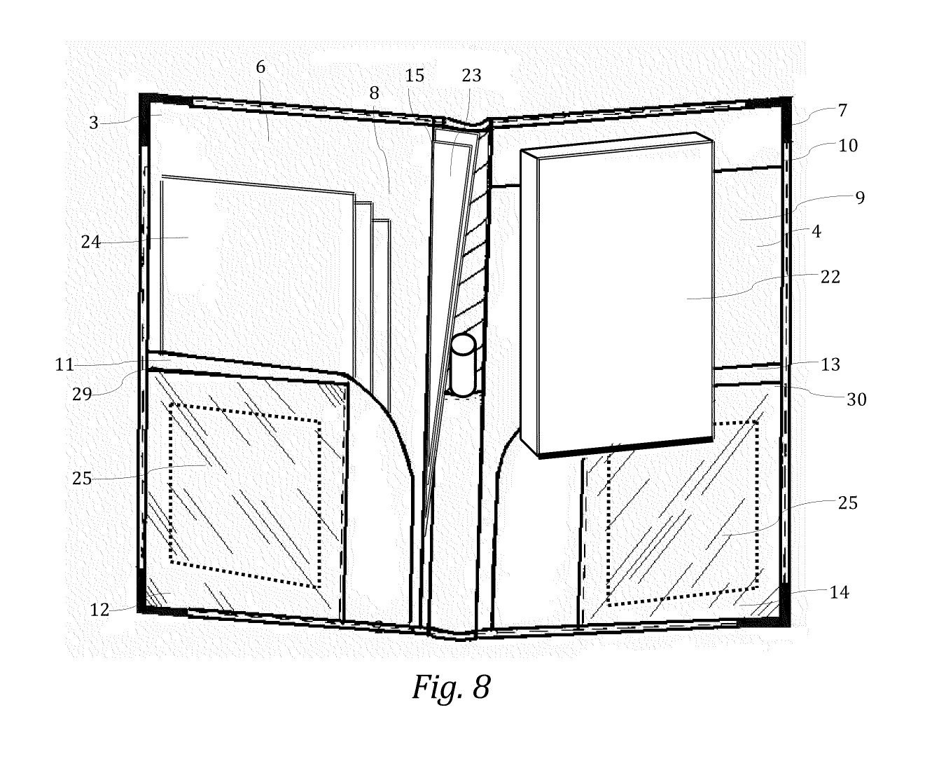

FIG. 3 illustrates the positioning and insertion of common waiter and waitress tools into the waiter organizer 1, including a multi-page order pad 22 positioned for attachment into pocket 9 through opening 10, currency bills 23 positioned for lose placement into pocket 8 through loose opening 15, paid or used order receipts 24 positioned into corner pocket 11, a writing utensil 26 positioned for pocket 16, and point of sale print receipts 25 positioned for placement in window pocket 12. FIGS. 8, 9, 10 and 11 show a waiter organizer 1 with a multi-page order pad 22, multi-page order pad 22 mounted in pocket 9, currency bills 23 placed in pocket 8, paid or used order receipts 24 placed in corner pocket 11, a writing utensil 26 placed in pocket 16, and point of sale print receipts 25 placed in window pockets 12 and 14.

The many aspects and benefits of the invention are apparent from the detailed description, and thus, it is intended for the following claims to cover such aspects and benefits of the invention, which fall within the scope, and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A waiter/waitress organizer comprising:
a portfolio having a first cover and a second cover being pivotally connected with a flexible hinge;
a first pocket on the internal surface of the first cover, wherein the first pocket is configured to removably hold a plurality of currency bills in a readily accessible position;
a second pocket on the internal surface of the second cover, wherein the second pocket is configured to removably hold a backing sheet of a multi page pad in a steady position on the portfolio;
a first corner pocket on the top surface of the first pocket;
a second corner pocket on the top surface of the second pocket, wherein the first and second corner pockets are substantially mirror images of each other;
a first substantially transparent pocket on the top surface of the first corner pocket; and
a second substantially transparent pocket on the top surface of the second corner pocket.

2. The waiter/waitress organizer of claim 1, wherein the portfolio and all pockets comprise a leather material.

3. The waiter/waitress organizer of claim 1, wherein the portfolio and all pockets comprise a vinyl material.

4. The waiter/waitress organizer of claim 1, further comprising a third substantially transparent pocket on the top surface of the first substantially transparent pocket.

5. The waiter/waitress organizer of claim 1, further comprising a fourth substantially transparent pocket on the top surface of the second substantially transparent pocket.

6. The waiter/waitress organizer of claim 1, further comprising a hinge pocket on the flexible hinge, wherein the hinge pocket is configured for removably holding a writing utensil with the portfolio in the open and closed positions.

7. The waiter/waitress organizer of claim 1, wherein the first and second corner pockets are each 4 to 7 inches in height.

8. The waiter/waitress organizer of claim 1, wherein the first and second corner pockets are each 3 to 5 inches in height.

9. The waiter/waitress organizer of claim 1, wherein the multi-page pad is a standard pad of restaurant order receipts.

10. The waiter/waitress organizer of claim 1, wherein the first and second substantially transparent pockets are each less than 3½ inches in width.

11. The waiter/waitress organizer of claim 1, wherein the first and second substantially transparent pockets are configured to only hold 5 or less sheets of standard point of sale (POS) paper receipts each having a thickness of 0.06 mm to 0.1 mm.

12. The waiter/waitress organizer of claim 1, wherein the front and back covers are each 6 to 12 inches in height.

13. The waiter/waitress organizer of claim 1, wherein the front and back covers are each 4 to 7 inches in width.

14. The waiter/waitress organizer of claim 1, wherein the portfolio is less than 2 inches in thickness in the closed position.

15. The waiter/waitress organizer of claim 1, wherein the portfolio is less than 1 inch in thickness in the open position.
